(19) United States
(12) Patent Application Publication
(10) Pub. No.: US 2005/0116429 A1
(43) Pub. Date: Jun. 2, 2005

(54) Fast and convenient operation structure of a screwdriver head socket

(76) Inventor: Sheng-Ming Chang, Daya Township (TW)

Correspondence Address: CHARLES E. BAXLEY, ESQ., 90 JOHN STREET, THIRD FLOOR, NEW YORK, NY, 10038, US

(21) Appl. No.: 10/724,933

(22) Filed: Dec. 1, 2003

(51) Int. Cl. B23B 31/107

(52) U.S. Cl. 279/75

(57) ABSTRACT

The present invention of a fast and convenient operation structure of a screwdriver head socket comprises an axial shaft with an inner bushing and a sliding socket element disposed on its outer surface, an elastic element is placed between the inner busing and the sliding socket element, a socket for sleeving the screwdriver head is disposed on the inner edge of the end of the axial shaft where the inner busing is disposed, a trough connecting outward is disposed on the inner surface of the socket, the inner bushing having a ball hole in corresponding to an appropriate place of the trough, the ball hole is for placing a positioning element, the sliding socket element having a pressing flange part and a retracting flange part in neighboring to each other, which are also in sectional flange structure, the two parts are disposed in corresponding to the inner surface of one end of the inner bushing, when one end of the positioning element is pressed against by the pressing flange part of the sliding socket element, the other end of the positioning element is protruded slightly from the trough, so that when the screwdriver head is inserted into the socket, the positioning element is pressed against to move and fall into the retracting flange part, after the screwdriver is positioned, the positioning element is then returned back to its original position by elastic force of the elastic element, at the same time, the outer edge of the positioning element is pressed against a concave positioning trough of the screwdriver head, thus the locking mechanism and sleeving process of the screwdriver head can be done with only one hand.

### BACKGROUND OF THE INVENTION

In order to make hexagonal screwdriver head socket more convenient and stable in usage, traditionally uses a socket with an elastic body and a steel ball. The steel ball is for locking and positioning the screwdriver head by locking at a groove on an angle of the hexagonal shape. Referring to FIG. 1 of a prior art. A cover 91 is being pulled back by the compression of a spring 92, so that a steel ball 93 is inserted into a groove 94 for clamping on a screwdriver 95. When the screwdriver 95 is placed in side the preset position, release the cover 91 to push the steel ball 93 to fall into the groove 94 to lock and position the screwdriver 95. Referring to FIG. 2, also a prior art uses a steel ball to clamp on a screwdriver. A big elastic body 83 is disposed between a cover 81 and a post 82, the post 82 having a small elastic body 84, sliding base 85 and a socket 86 inside, a positioning piece 87 and an upper cover 88 are used for combining and positioning. When a screwdriver is inserted into a socket 86, the small elastic body 84 is being compressed and the big elastic body 83 is pressed against the cover 91, so that a steel ball 89 falls into a circular groove 90 of the screwdriver. When the screwdriver is being taken out, the cover 91 is being pulled back and the steel ball 89 is released, so the screwdriver is finally bounced out by the small elastic body 84.

Referring to FIG. 3, yet another prior art. It mainly comprises a socket shaft, a sliding ring, a spring and a positioning piece. The sliding ring is in cylindrical shape and is hollow inside with a front inner ring disposed at the front, a pyramidical shaped ring and a big inner ring are disposed by its sides. The socket shaft having a hexagonal hole at the front and a ring groove for placing a ring, the ring and the spring are orderly disposed on the utter diameter of the socket shaft. The inner ring at the front of the sliding ring is pressed against the positioning piece as one body. A positioning groove is disposed at the front of the socket shaft, the positioning groove is connected to the hexagonal hole and is for placing the positioning piece. When the inner ring at the front of the sliding ring is pressed against the positioning piece, the sharp end of the positioning piece is inserted into a V-shaped groove of a screwdriver. Accordingly, it is a firm and convenient method of clamping the screwdriver. The drawbacks are, users must push the sliding ring backwards towards the socket shaft in order to release the screwdriver from the positioning piece or the steel ball that are used for locking and positioning the screwdriver. A user must use both hands to achieve this, which is not convenient at all.

So that another prior art which only required on hand was invented as referring to FIGS. 4 and 5. It mainly comprises a post 71 with a space inside, the space comprises a first space 711 and a second space 712, the first space 711 is for inserting a tool head, a positioning device 72 which is fixed on one side of the post 71 for locking the tool head, a sleeving tube 73 which is disposed outside the post 71, an elastice body 74 is disposed between the sleeving tube 73 and the post 71 to provide elasticity for the sleeving tube 73, a stopping device 77 is fixed on the post 71 for limiting the sleeving tube 73 inside the first space 711 and the second space 712 of the post 71, and preventing the sleeving tube 73 depart from the post 71 when it is moved to-and-fro outside the post 71. A bottom sleeve 75 is fixed inside the second space 712 of the post 71, a small elastic body 76 is disposed between the bottom sleeve 75 and the post 71. Accordingly, when the sleeve tube 73 slides toward the second space 712 of the post 71, the tool head is sleeved inside the post 71. By the locking mechanism of the positioning device 72 and the compression of the small elastic body 76, when the tool head is locked inside the post 71, user can further slides the sleeve tube 73 toward the second space 712 of the post 71, so that the positioning piece 72 loses its locking mechanism on the tool head, so that the small elastic body 76 of the bottom sleeve 75 bounces the tool head out to the first space 711. Thus users can insert and take out the screwdriver by only using one hand.

This prior art also has its drawbacks. The positioning device falls into the steel ball groove, and by compression to limit movement of the sleeve tube by the pressing of the big elastic piece, therefore, the screwdriver can be inserted inside the post and locked by the positioning device, which does not need both hands to operate. Reversely, the screwdriver can also be taken out. But when users need to take out the screwdriver, if the movement of the sleeve tube being moved down to let the positioning piece falls into the steel ball groove and afterwards being released and back to position, is faster than the small elastic body presses against the sliding base, then the positioning device will protrudes at the first space before being positioned, so that the sliding base cannot moves to be positioned as shown in FIG. 6. Therefore if users need to insert the screwdriver again, must need to use one hand to move the sleeve tube downward, with another hand to insert the screwdriver. Also the small elastic body for providing elasticity to the sliding base back to position will loses its elasticity after a certain period of usage, which will affect the stability of the positioning device.

### SUMMARY OF THE INVENTION

The present invention of a fast and convenient operation structure of a screwdriver head socket allows users to insert and take out the screwdriver with ease and convenience.

It mainly comprises an axial shaft, an inner bushing and a sliding socket element. A socket for sleeving the screwdriver head is disposed on the inner edge of the end of the axial shaft where the inner busing is disposed, a trough connecting outward is disposed on the inner surface of the socket, the inner bushing having a ball hole in corresponding to an appropriate place of the trough, the ball hole is for placing a positioning element, the sliding socket element having a pressing flange part and a retracting flange part in neighboring to each other, which are also in sectional flange structure, the two parts are disposed in corresponding to the inner surface of one end of the inner bushing, when one end of the positioning element is pressed against by the pressing flange part of the sliding socket element, the other end of the positioning element is protruded slightly from the trough, so that when the screwdriver head is inserted into the socket, the positioning element is pressed against to move and fall into the retracting flange part, after the screwdriver is positioned, the positioning element is then returned back to its original position by elastic force of the elastic element, at the same time, the outer edge of the positioning element is pressed against a concave positioning trough of the screwdriver head, thus the locking mechanism and sleeving process of the screwdriver head can be done with only one hand.

The present invention will become more fully understood by reference to the following detailed description thereof when read in conjunction with the attached drawings

### BRIEF DESCRIPTION OF THE DRAWINGS

FIG. 1 is a sectional assembly view of a first prior art;

FIG. 2 is a sectional assembly view of a second prior art;

FIG. 3 is a sectional assembly view of a third prior art;

FIG. 4 is a sectional assembly view of a fourth prior art;

FIG. 5 is a sectional assembly view of the fourth prior art with a screwdriver inserted;

FIG. 6 is a sectional assembly view of the fourth prior art showing its drawbacks;

FIG. 7 is a perspective view of a fast and convenient operation structure of a screwdriver head socket of the present invention;

FIG. 8 is an exploded view of a fast and convenient operation structure of a screwdriver head socket of the present invention;

FIG. 9 is an exploded view of a second embodiment of the present invention;

FIG. 10 is a sectional assembly view of the present invention before a screwdriver is inserted;

FIG. 11 is a sectional assembly view of the present invention while a screwdriver is being inserted;

FIG. 12 is a sectional assembly view of the present invention after a screwdriver is inserted and positioned;

FIG. 13 is a sectional assembly view of the present invention with a screwdriver being bounced out;

FIG. 14 is a sectional assembly view of a third embodiment of the present invention;

FIG. 15 is a sectional assembly view of the second embodiment of the present invention;

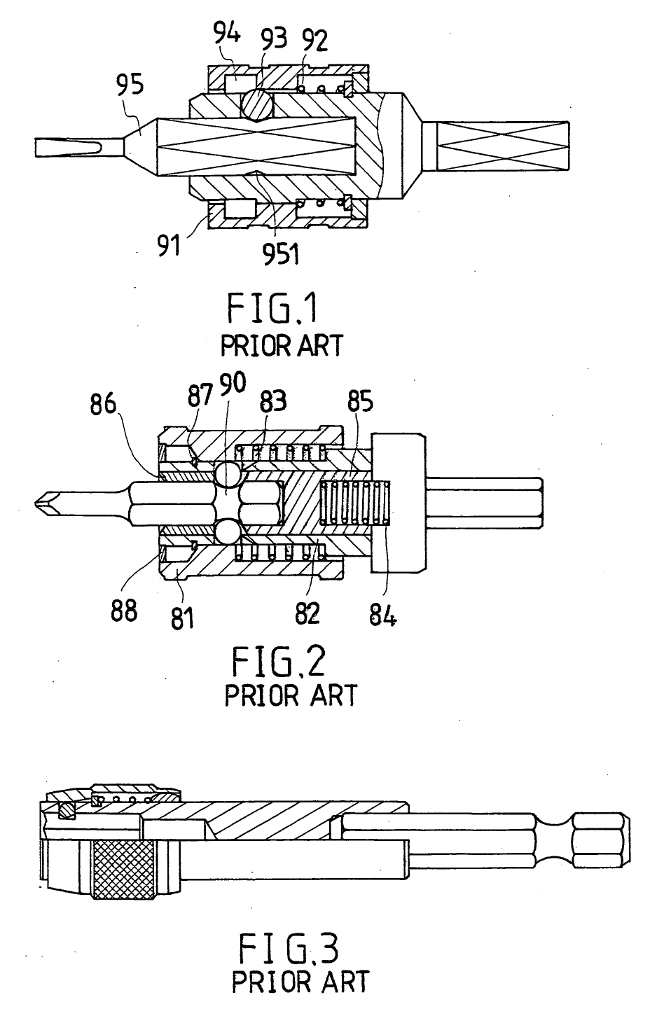

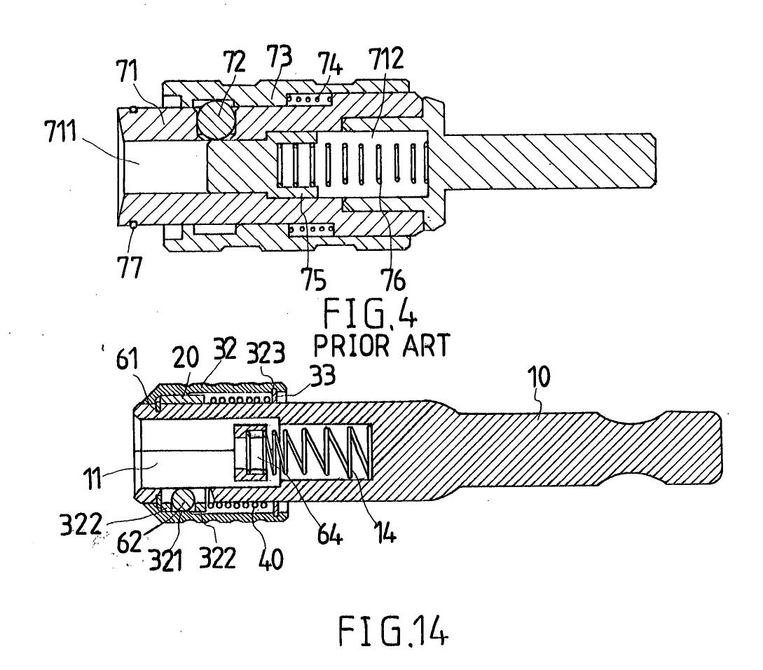

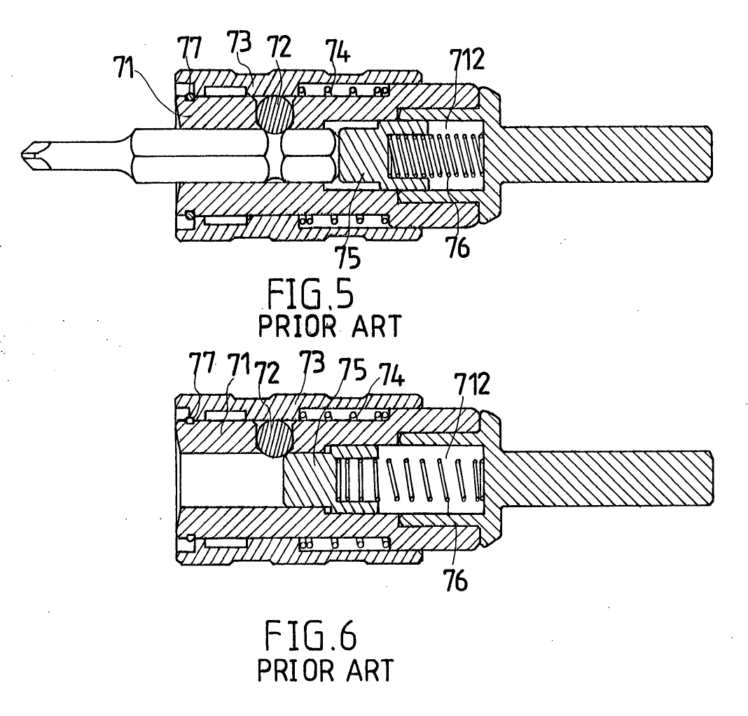

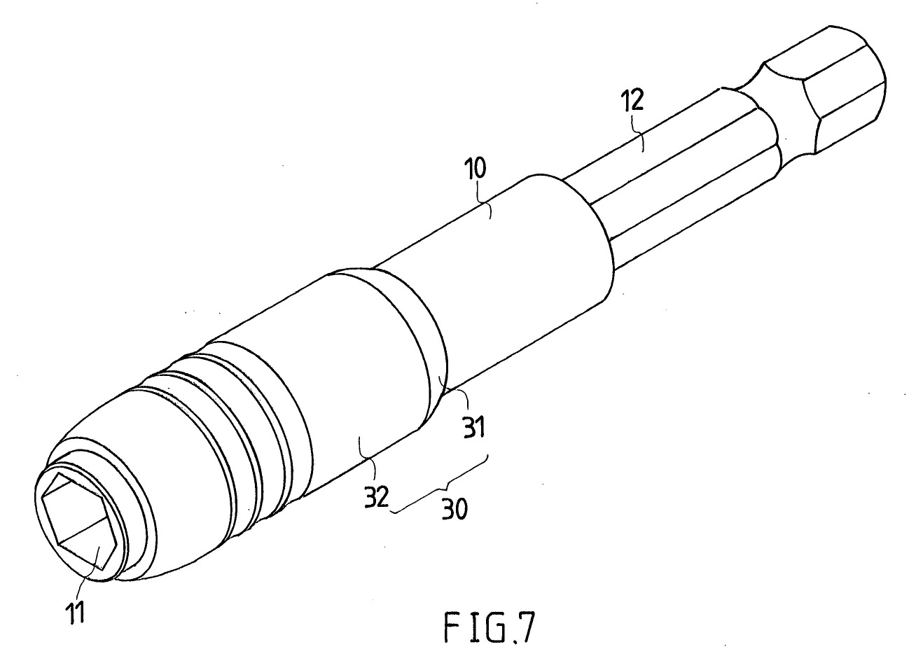

### DETAILED DESCRIPTION OF THE PREFERRED EMBODIMENT

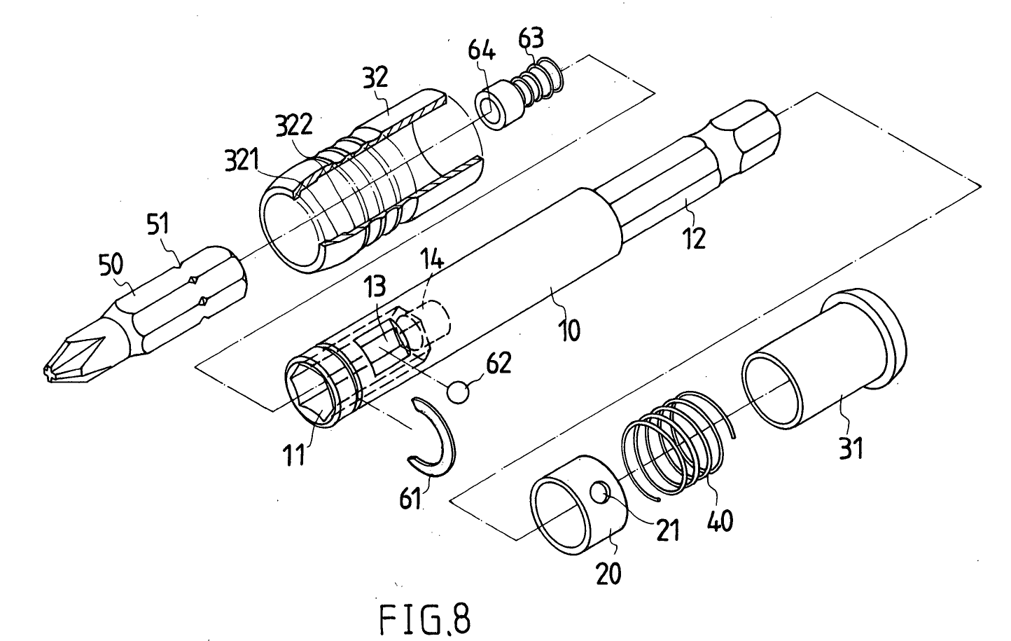

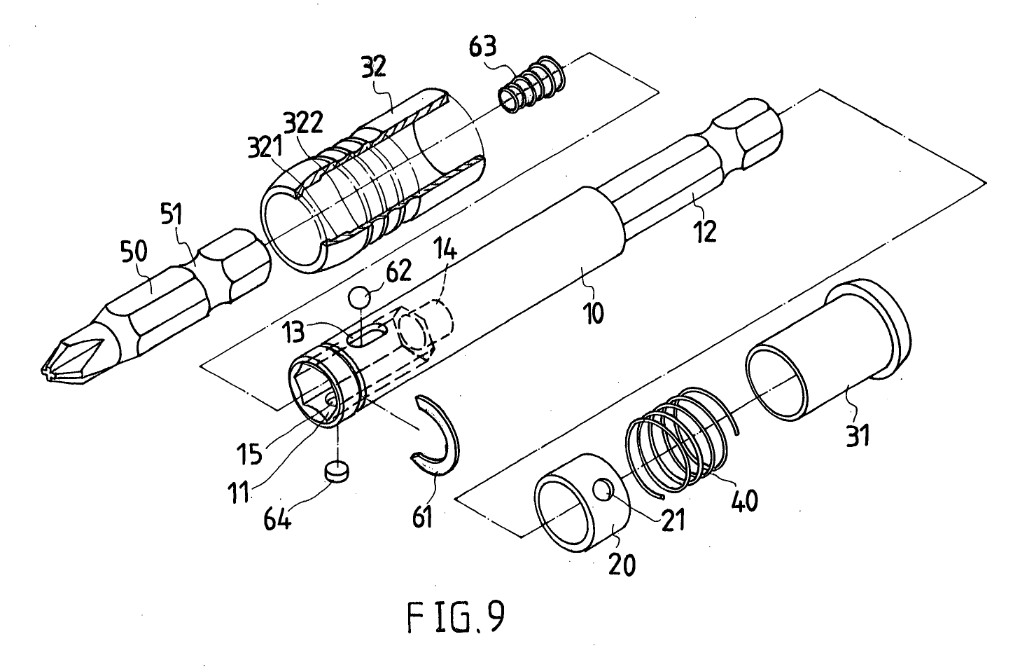

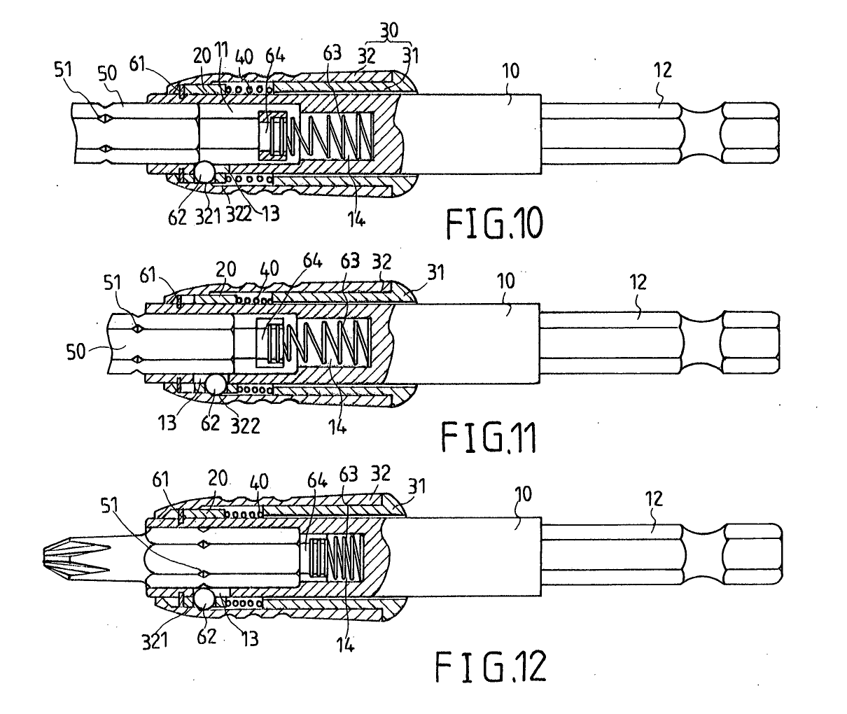

Referring to FIGS. 7 to 12, the present invention mainly comprises an axial shaft 10, an inner bushing 20 for sleeving on the axial shaft. The axial shaft is a long body with its one end having a socket 11 for inserting a screwdriver head 50, another end having a connecting section 12 for connecting to an electric driver tool. The socket 11 having a stopping ring 61 disposed on its outer circumference for accurate and stable positioning of the inner bushing 20. A trough 13 connecting to the outside is disposed on the inner surface of the socket 11 in corresponding to the hexagonal shape of the screwdriver head 50. The position and shape of the trough 13 depends on the shape of a concave positioning trough 51 on the screwdriver head 50. Referring to FIG. 8, when the concave positioning trough 51 of the screwdriver head 50 are formed on each of the hexagonal angles, the trough 13 can be formed by milling at one of the hexagonal angles of the socket 11 of the axial shaft 10. Referring to FIG. 9, if the concave positioning trough 51 is formed on a suitable location on the hexagonal circumference of the screwdriver head 50, then the trough 13 has to be formed on a hexagonal surface of the socket 11 of the axial shaft 10. In other words, the present invention is not limited by the structure and shape of the concave positioning trough 51 of the screwdriver head 50.

The inner bushing 20 is a ring sleeve for sleeving on the trough 13 of the axial shaft 10. A ball hole 21 is disposed on the inner bushing 20 in corresponding to the trough 13 for placing a positioning element 62. The positioning element 62 is a steel ball for placing between the ball hole 21 and the trough 13. A sliding socket element 30 is disposed on the axial shaft 10. The sliding socket element 30 having an inner shaft sleeve 31 and an outer shaft sleeve 32, the inner shaft sleeve 31 can sleeve on the middle part of the axial shaft 10 while the outer shaft sleeve 32 is sleeved on the inner shaft sleeve 31 and also cover the inner bushing 20. An elastic element 40 is disposed between the inner bushing. 20 and the inner shaft sleeve 31. A pressing flange part 321 and a retracting flange part 322 are in neighboring to each other, which are also in sectional flange structure, are formed on the inner surface of the outer shaft sleeve 32 in corresponding to the positioning element 62. When the positioning element 62 is placed between the ball hole 21 and the trough 13, its one end is pressed by the pressing flange part 321 and its another end is slightly protruded outside the trough 13, which is on the path of the screwdriver head 50 being inserted into the socket 11.

Referring to FIG. 14, the sliding socket element 30 can also be formed by the outer shaft sleeve 32 and a positioning ring 33. The outer shaft sleeve 32 having a positioning trough 323 disposed on the inner surface at its end for the positioning ring 33 to hook on. This is for the replacement of the inner shaft sleeve 31. When the outer shaft sleeve 32 is sleeved on the axial shaft 10, the both ends of the elastic element 40 are being pressed between the inner bushing 20 and the positioning ring 33.

Accordingly, since the positioning element 62 is protruded outside on the path, when the screwdriver head 50 is inserted into the socket 11, the positioning element 62 is being pushed and the inner bushing 20 is being moved, and at the same time, the elastic element 40 is being compressed. When the positioning element 62 is being moved to the retracting flange part 322, the screwdriver head 50 can be inserted and positioned, Then the positioning element 62 can be bounced back to its original position by the elasticity of the elastic element 40, and is also positioned on the concave positioning trough 51 of the screwdriver head 50. Thus the screwdriver head can be inserted and taken out by using only one hand conveniently and stably.

Users can simply push the outer shaft sleeve 32 towards the socket 11, to let the positioning element 62 falls into the retracting flange part 322, so as to release the positioning element 62 from the screwdriver head 50, in order to take out the screwdriver head 50. An elastic body 63 and an attraction body 64 can be placed inside an extended groove 14 disposed at the inside end of the socket 11 of the axial shaft 10, in order to provide further convenience for taking out the screwdriver head 50.

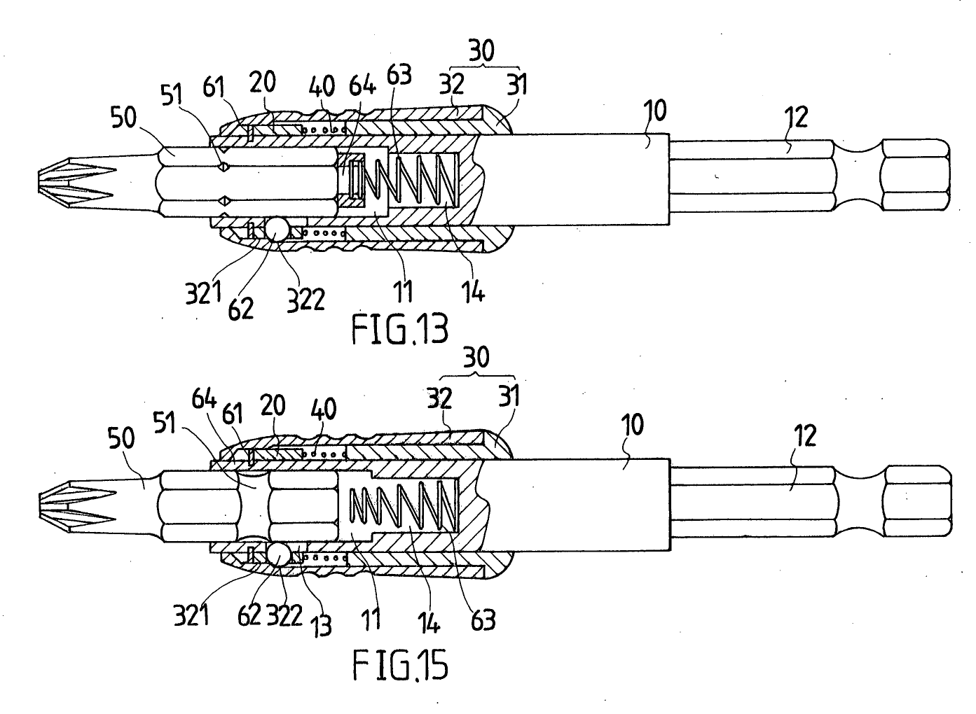

When the screwdriver head 50 is inserted inside the socket 11, it can be attracted by the attraction body 64. When the locking mechanism for locking and positioning the screwdriver head 50 by positioning element 62 disappeared, the elastic body 63 can bounces the screwdriver head 50 out from the socket 11 as referring to FIG. 13.

Referring to FIG. 9 again, with demonstration of FIG. 15, the attraction body 64 can also be placed inside the inner surface of the socket 11 at a suitable location, a hole 15 is disposed on the inner surface of the socket 11 at a suitable location for placing the attraction body 64.

Thus, the present invention can provide a stable locking and positioning mechanism for the screwdriver head, and can also provide convenience and practicability for operating the tool by using only one hand.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1. A fast and convenient operation structure of a screwdriver head socket mainly comprises an axial shaft, one end of said axial shaft having a socket for inserting a screwdriver head, its other end having a connecting section, a trough connecting outward is disposed on the inner surface of said socket at a suitable location;
an inner bushing is sleeved on said trough of said axial shaft at a suitable location, a ball hole is disposed on said inner bushing in corresponding to said trough for placing a positioning element;
a sliding socket element is sleeved on said axial shaft and also cover said inner bushing, a pressing flange part and a retracting flange part are in neighboring to each other, which are also in sectional flange structure, are formed on said sliding socket element in corresponding to said positioning element, an elastic element is disposed between said sliding socket element and said inner bushing;
one end of said positioning element is being pressed by said pressing flange part of said sliding socket element, and another end is slightly protruded outside said trough, which is on the path of said screwdriver head being inserted into said socket, when said screwdriver head is inserted into said socket, said positioning element is being pressed and falls into said retracting flange part, after said screwdriver is positioned, said positioning element is then returned back to its original position by elastic force of said elastic element, at the same time, the outer edge of said positioning element is pressed against a concave positioning trough of the screwdriver head, thus to provide a convenient structure for inserting and taking out of said screwdriver head by using only one hand.

2. A fast and convenient operation structure of a screwdriver head socket as claimed in claim 1, said axial shaft having a stopping ring disposed on its outer circumference for accurate and stable positioning of said inner bushing.

3. A fast and convenient operation structure of a screwdriver head socket as claimed in claim 1, said sliding socket element can be formed by an inner shaft sleeve and an outer shaft sleeve, said inner shaft sleeve is sleeved on the back of said elastic element so that said elastic element can press against on its outer edge, said outer shaft sleeve is sleeved on said inner shaft sleeve, said pressing flange part and said retracting flange part are formed on the inner surface of said outer shaft sleeve at suitable locations.

4. A fast and convenient operation structure of a screwdriver head socket as claimed in claim 1, said concave positioning trough of said screwdriver head can be disposed at each angle of its hexagonal angles are around its hexagonal circumference.

5. A fast and convenient operation structure of a screwdriver head socket as claimed in claim 1, said trough can be formed by milling at one of the hexagonal angles of said socket of said axial shaft, in corresponding to the structure of said concave positioning trough disposed at each angle of said screwdriver head's hexagonal angles.

6. A fast and convenient operation structure of a screwdriver head socket as claimed in claim 1, said trough can be formed at one of the hexagonal sides of said socket of said axial shaft, in corresponding to the structure of said concave positioning trough disposed on each side of said screwdriver head's hexagonal circumference.

7. A fast and convenient operation structure of a screwdriver head socket as claimed in claim 1, an elastic body and an attraction body can be placed inside said socket of said axial shaft on the opposite direction of said screwdriver head, said attraction body can be fixed on one end of said elastic body, when said screwdriver head is inserted into said socket, it can be attracted by said attraction body, when the locking mechanism locking the screwdriver head by said positioning element disappeared, said elastic body can bounces out said screwdriver head from said socket.

8. A fast and convenient operation structure of a screwdriver head socket as claimed in claim 1, said positioning element is a steel ball.

9. A fast and convenient operation structure of a screwdriver head socket as claimed in claim 1 or claim 2, said sliding socket element can be formed by an outer shaft sleeve and a positioning ring, said outer shaft sleeve having a positioning trough disposed on the inner surface at its end for said positioning ring to hook on, when said outer shaft sleeve is sleeved on said axial shaft, the both ends of said elastic element are being pressed between said inner bushing and said positioning ring, said pressing flange part and said retracting flange part are formed on the inner surface of said outer shaft sleeve.

10. A fast and convenient operation structure of a screwdriver head socket comprises an axial shaft, its one end having a socket for inserting said screwdriver head, an inner bushing, a sliding socket element and a positioning element are disposed outside said axial shaft, an extended groove is disposed inside and connected to said socket for placing an elastic body and an attraction body, when said screwdriver head is inserted into said socket, said elastic body is being pressed against and said screwdriver head is attracted by said attraction body, when said screwdriver head is being released from the locking mechanism, said elastic body can bounces said screwdriver head outside said socket, said attraction body can prevent said screwdriver head from falling to the ground by its attraction force.

11. A fast and convenient operation structure of a screwdriver head socket as claimed in claim 10, said inner bushing and said sliding socket element are sleeved on said axial shaft at suitable locations, an elastic element is disposed between said inner bushing and said sliding socket element, said positioning element is disposed on a steel ball hole of said inner bushing, when said screwdriver head is inserted into said socket, said positioning element can lock on a concave positioning trough disposed on said screwdriver head.

12. A fast and convenient operation structure of a screwdriver head socket as claimed in claim 10, said attraction body can be fixed on one end of said elastic body.

13. A fast and convenient operation structure of a screwdriver head socket as claimed in claim 10 and claim 12, said attraction body can be disposed in a hole on the inner surface of said socket at a suitable location.

14. A fast and convenient operation structure of a screwdriver head socket as claimed in claim 10, said sliding socket element can be formed by an inner shaft sleeve and an outer shaft sleeve, said inner shaft sleeve is sleeved on the back of said elastic element so that said elastic element can press against on its outer edge, said outer shaft sleeve is sleeved on said inner shaft sleeve, a pressing flange part and a retracting flange part are in neighboring to each other, which are also in sectional flange structure, are formed on the inner surface of said outer shaft sleeve in corresponding to said positioning element.

15. A fast and convenient operation structure of a screwdriver head socket as claimed in claim 10 or claim 14, said sliding socket element can be formed by an outer shaft sleeve and a positioning ring, said outer shaft sleeve having a positioning trough disposed on the inner surface at its end for said positioning ring to hook on, when said outer shaft sleeve is sleeved on said axial shaft, the both ends of said elastic element are being pressed between said inner bushing and said positioning ring.
